(19) United States
(12) Patent Application Publication
(10) Pub. No.: US 2023/0127063 A1
(43) Pub. Date: Apr. 27, 2023

(54) A FIBER BRAGG GRATING MONITORING DEVICE FOR DYNAMIC DISASTERS IN COAL MINES

(71) Applicant: Henan Polytechnic University, Jiaozuo City (CN)

(72) Inventors: Shiming Wei, Jiaozuo City (CN); Zesheng Zhang, Jiaozuo City (CN)

(21) Appl. No.: 17/049,259

(22) PCT Filed: May 15, 2020
(86) PCT No.: PCT/CN2020/090606

§ 371 Date: Oct. 20, 2020

(30) Foreign Application Priority Data
Nov. 27, 2019 (CN) 201911182466.7

(51) Int. Cl. E21F 17/18; G01V 1/00; G01V 1/28; G01V 1/30

(52) U.S. Cl. CPC E21F 17/185; G01V 1/003; G01V 1/288; G01V 1/307

(57) ABSTRACT

This invention provides a fiber Bragg grating (FBG) monitoring device for dynamic disasters in coal mines. It includes a data acquisition device, which is used to collect the seismic wave signal in coal mines and reflect the possibility of the current coal and gas outburst hazard through the seismic wave signal described; a data processing device, which is used to process the collected data, eliminate the interferential signal and convert the effective signal into the measured physical quantity, and then send it to the display unit or save it; a real-time processor, which is used to achieve the acquisition and processing of real-time data; a display unit, which is used for the process of acquisition, storage, display and historical data query, and the display of residual capacity; a power supply unit, which is used to provide energy for the whole monitoring device.

### FIELD OF THE INVENTION

This invention relates to the field of monitoring equipment for dynamic disaster in coal mines, especially to a FBG monitoring device for dynamic disasters in coal mines.

### BACKGROUND OF THE INVENTION

In recent years, with the increasing of mining depth and intensity, the geological conditions tend to be more complex, the mine safety situation becomes more severe, and the probability of various disasters has also increased evidently. The frequent occurrence of coal mine disasters has caused various accidents and inestimable economic losses. Among the accidents, the disasters caused by coal and rock dynamic damage are the most destructive and the most difficult to prevent. The major countries of coal mining in the world, whether developed or developing ones, had suffered this severely. However, for the randomness, complexity and diversity, and suddenness, and the uncertainty of beginning time, place, region, source and other factors, the coal and rock dynamic disaster is so complicated that its occurrence is extremely difficult to predict. According to the characteristics, field needs and technology development trend of coal and rock dynamic disasters, the development trend in the future for prevention covers comprehensive, real-time and quantitative monitoring and warning for dynamic disasters in coal mine.

At present, the traditional electronic and mechanical sensors used for monitor in coal mines have single measurement parameter and lower system response frequency, making it difficult to achieve real-time monitoring. The electrical sensors have several defects, such as large volume, being susceptible to electromagnetic interference, and prone to electric sparks, possibly contributing to accidents in coal mines. Therefore, it is so necessary to provide a safe monitoring device which can test the useful parameters of coal mine in real time and accurately.

### SUMMARY OF THE INVENTION

This invention is to provide a FBG monitoring device for dynamic disasters in coal mines, so as to solve the current problems mentioned above.

In order to achieve the above, this invention provides the following scheme, i.e. a FBG monitoring device for dynamic disasters in coal mines, which consists of:

Data acquisition device, which is used to collect the seismic wave signal in coal mines and reflect the possibility of outburst hazard through the seismic wave signal described;

Data processing device, which is used to process the collected data, eliminate the interferential signal, convert the effective signal into the measured physical quantity, and then send it to the display unit or save it;

Real-time processor, which is used to achieve the acquisition and processing of real-time data;

Display unit, which is used for the process of acquisition, storage, display and historical data query, and the display of residual capacity;

Power supply unit, which is used to provide energy for the whole monitoring device;

The power supply unit described is connected with the data acquisition device, data processing device, real-time processor and display unit, respectively, the data acquisition device described is connected with the data processing device described, and the real-time processor described is connected with the data acquisition device and the data processing device.

Preferably, the data acquisition device adopts parameters by distributed point with multiple channels for synchronous acquisition, and amplifies the seismic wave signal by the preamplifier of each channel.

Preferably, the data acquisition device described includes a wireless sensor and a wireless transceiver device, and the transceiver includes a power supply, a signal receiver and a controller. The signal receiving device is connected with the wireless sensor, and the power supply described provides energy for the signal receiver and controller.

Preferably, the data processing device described includes a setting module, a judgment module and an elimination module. The setting module described is connected with the judgment module, and the judgment module described is connected with the elimination module. The setting module described sets the frequency range of the seismic wave signal in advance, and judges whether the signal to be detected falls within the frequency range through the judgment module described.

Preferably, it also includes an alarm unit, which is connected with the data processing device used for early warning of dynamic disasters in coal mines. In the alarm unit described, the variation range of FBG wavelength is preset, corresponding to different levels of vibration.

Preferably, the display unit described includes a history data query module used to query the historical alarm and other data in a certain period of time.

This invention discloses the following technical effects: This invention collects the seismic wave signal in coal mines through the data acquisition device, then sends it to the data processing device through the seismic wave signal. By processing the collected data, eliminating the interferential signal, converting the effective signal into the measured physical quantity, the signal will be then sent to the display unit or saved in it. The real-time storage, display and alarm of data will be achieved by the real-time processor, and this will facilitate the later query and guarantee the real-time and accurate monitoring for dynamic disasters in coal mines. By monitoring the seismic wave signal produced by micro fracture of rock and coal under internal or external disturbance, the stability of coal and rock can be reflected, and the monitoring and early warning of disasters will be achieved.

### BRIEF DESCRIPTION OF THE DRAWINGS

In order to illustrate more clearly the implementation plan of this invention or the technical scheme in the existing technology, the FIGURES in the implementation plan will be briefly introduced below. Obviously, the figures are only some of this invention. For those ordinary technical personnel in this field, they also have access to other FIGURES according to these without creative labor.

FIG. 1 is the structural diagram of this invention.

### DETAILED DESCRIPTION OF THE INVENTION

The technical scheme in the implementation plan of this invention will be described clearly and completely with the FIGURES. Obviously, the implementation plan described is only part of this invention. Based on the implementation plan, all others obtained by those ordinary technical personnel without creative labor belong to the scope of protection of this invention.

In order to make the purpose, features and advantages of this invention more popular and easier to understand, it will be further described in detail with reference to the figures and specific implementation plan.

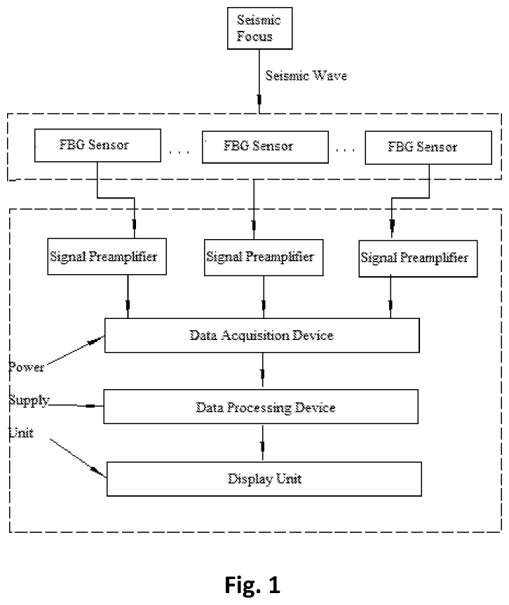

As shown in FIG. 1, a FBG monitoring device for dynamic disasters in coal mines includes:

Data acquisition device, which is used to collect the seismic wave signal in coal mines and reflect the possibility of the current dynamic disasters in coal mines through the seismic wave signal described;

Data processing device, which is used to preprocess the collected data, eliminate the interferential signal and convert the effective signal into the measured physical quantity, obtain the variation law of dynamic disaster process parameters of coal mines, and then send it to the display unit or save it;

Real-time processor, which is used to achieve the acquisition and processing of real-time data;

Display unit, which is used for collecting, saving and displaying the historical data, and displaying the acquisition process and residual capacity. In case of temperature alarm, the real-time details will pop up at the lower right corner.

Power supply unit, which is used to provide energy for the whole monitoring device.

The power supply unit described is connected with the data acquisition device, data processing device, real-time processor and display unit, respectively, and the data acquisition device described is connected with the data processing device described. The real-time processor described is connected with the data acquisition device and the data processing device.

In order to further optimize the scheme, the data acquisition device adopts parameters by distributed point with multiple channels for synchronous acquisition, and amplifies the seismic wave signal by the preamplifier of each channel.

The data acquisition device described includes a wireless sensor and a wireless transceiver device, the transceiver device described includes a power supply, a signal receiver and a controller. The signal receiving device described is connected with the wireless sensor, and the power supply described provides energy for the signal receiver and the controller. The wireless sensor described includes a FBG sensor, which monitors the seismic wave signal in real time. Because the sound wave intensity generated by gas leakage is often weak, the fibers used in the sensors are index graded multimode fibers.

Preferably, the data processing device described includes a setting module, a judgment module and an elimination module. The setting module described is connected with the judgment module, and the judgment module described is connected with the elimination module. The setting module described sets the frequency range of the seismic wave signal in advance, and judges whether the detected signal falls within the frequency range through the judgment module described. If so, it will be judged as effective signal, otherwise as interferential signal; when it is judged as error interferential signal, the elimination module will eliminate it.

In order to further optimize the scheme, it also includes an alarm unit, which is connected with the data processing device used for early warning of dynamic disasters in coal mines. In the alarm unit described, the variation range of wavelength is preset, corresponding to different levels of vibration.

In order to further optimize the scheme, the display unit described includes a history data query module used to query the historical alarm and other data in a certain period of time.

In order to further optimize the scheme, due to the high-speed transmission of so much data, high-speed serial bus is adopted for real-time data processing. In addition, it is necessary to measure the tilt and jittery clock signal of multi-channel clock signals in real time, and then adjust and calibrate their respective parameters according to the results. Besides, a correction algorithm is also designed, and a high stability clock source and a clock allocation network with variable delay line are used to calibrate the clock.

System permission setting: As for the administrator and ordinary users, the function pages may be set by permission, and users with different permissions may modify their login password.

The working process is as follows: When the rock damages, the FBG sensor collects the seismic wave signal, converts it into electrical signal, and then amplifies it through the signal preamplifier to improve the signal-to-noise ratio, and filters the undesired interferential signal, which not only improves the gain but reduces the noise. Then it sends the signal to the data processing device for high-speed digital signal processing, and transmits the processing results to the real-time processor through PCI bus. Then the real-time processor sends the results to the display unit and data processing device, and the judgment module judges whether the signal to be detected falls within the set frequency range or not. If so, it is judged as normal signal, otherwise as interferential signal; when it is judged as interferential signal, the elimination module will eliminate it. When the detected light path changes within the normal range, it is safe in the mine. If the light path changes beyond the normal range, the alarm unit will be triggered and the current vibration level will be displayed.

In the description of this invention, it is very necessary to be understood that the terms “longitudinal”, “transverse”, “up”, “down”, “front”, “back”, “left”, “right”, “vertical”, “horizontal”, “top”, “bottom”, “inside” and “outside”, etc. are based on the direction or position relationship shown in the figures. They are only for the convenience of describing this invention, rather than indicating or implying that the device or element referred to must have a particular position, be constructed and operated in a particular direction. So these shouldn't be as a limitation of this invention.

The implementation plans described above only describe the preferred methods of this invention, and are not restrictions on the scope of this invention. Without departing from the design spirit of this invention, all kinds of deformations and improvements made by ordinary technical personnel in this field to the technical scheme of this invention shall fall into the scope of protection determined in the claims of this invention.

1. A FBG monitoring device for dynamic disasters in coal mines is characterized in that it is composed of the following parts:
data acquisition device, which is used to collect the seismic wave signal in coal mines and reflect the possibility of outburst hazard in the current coal mine through the seismic wave signal described;
data processing device, which is used to process the collected data, eliminate the interferential signal and convert the normal signal into the measured physical quantity, and then send it to the display unit or save it;
real-time processor, which is used to achieve the acquisition and processing of real-time data;
display unit, which is used for the process of acquisition, storage, display and historical data query, and the display of residual capacity;
power supply unit, which is used to provide energy for the whole monitoring device.
the power supply unit described is connected with the data acquisition device, data processing device, real-time processor and display unit, respectively, the data acquisition device described is connected with the data processing device described, and the real-time processor described is connected with the data acquisition device and the data processing device.

2. The FBG monitoring device for dynamic disasters in coal mines described according to claim 1 is characterized in that the data acquisition device adopts parameters by distributed point with multiple channels for synchronous acquisition, and amplifies the seismic wave signal by the preamplifier of each channel.

3. The FBG monitoring device for dynamic disasters in coal mines described according to claim 1 is characterized in that the data acquisition device described includes a wireless sensor and a wireless transceiver device, and the transceiver includes a power supply, a signal receiver and a controller. The signal receiving device is connected with the wireless sensor, and the power supply described provides energy for the signal receiver and controller.

4. The FBG monitoring device for dynamic disasters in coal mines described according to claim 1 is characterized in that the data processing device described includes a setting module, a judgment module and an elimination module. The setting module described is connected with the judgment module, which is connected with the elimination module. The setting module described sets the frequency range of the seismic wave signal in advance, and judges whether the signal to be detected falls within the frequency range through the judgment module described.

5. The FBG monitoring device for dynamic disasters in coal mines described according to claim 1 is characterized in that it also includes an alarm unit, and the alarm unit described is connected with the data processing device, which is used for the early warning of dynamic disasters in coal mines. In the alarm unit described, the variation range of FBG wavelength is preset, corresponding to different levels of vibration.

6. The FBG monitoring device for dynamic disasters in coal mines described according to claim 1 is characterized in that the display unit described includes a historical data query module used to query the historical alarm and other data in a certain period of time.
